(19) United States
(12) Patent Application Publication
(10) Pub. No.: US 2014/0083392 A1
(43) Pub. Date: Mar. 27, 2014

(54) METHODS FOR CONTROLLING ENGINE IDLE SPEED

(71) Applicant: INTERNATIONAL ENGINE INTELLECTUAL PROPERTY COMPANY, Lisle, IL (US)

(72) Inventors: Luis Carlos Cattani, Aurora, IL (US); Michael Uchanski, Chicago, IL (US); Rogelio Rodiguez, Plainfield, IL (US); James Ciglar, Lockport, IL (US); Jer Shen Jason Chen, Naperville, IL (US); Dileep Khadilkar, Naperville, IL (US); Rahul Dev Rajampeta, Elmhurst, IL (US); Ravi Rayala, Aurora, IL (US)

(73) Assignee: International Engine Intellectual Property Company, LLC, Lisle, IL (US)

(21) Appl. No.: 13/629,261

(22) Filed: Sep. 27, 2012

(51) Int. Cl. F02M 3/00

(52) U.S. Cl. 123/339.24; 123/350; 123/339.14

(57) ABSTRACT

The present technology provides one or more methods of operating an engine in a motor vehicle. In at least one embodiment, the existence of an engine idle condition is determined. The method may also include determining whether an operator is present in the vehicle. In some embodiments, the engine operates at a performance idle speed when an engine idle condition exists and an operator is present in the vehicle. In further embodiments, the engine operates at a fuel economy idle speed when an idle condition exists and no operator is present in the vehicle. In still further embodiments, the fuel economy idle speed will be lower than the performance idle speed. The present technology anticipates engine workload and controls engine idle speeds. Based on the anticipated workloads, the present technology can reduce engine stalling while also reducing emissions and increasing fuel economy.

### BACKGROUND

Engine idle speed control systems serve several purposes. For example, engine idle speed control systems can help to improve the fuel efficiency, reduce exhaust emissions engine, and help maintain the engine operating at a suitable temperature. Additionally, engine idle speed control systems also help to prevent the engine from stalling when additional loads are placed on the engine. Accordingly, use of an effective engine idle speed control strikes a balance between operating an engine at an engine idle speed that is low enough to be fuel efficient and environmentally acceptable, yet high enough to prevent the engine from stalling when sudden loads are placed on the engine.

Employing an engine idle speed control method that effectively anticipates forthcoming engine loads can result in a more efficient engine operation, while preventing engine stall and achieving fuel economy and emissions control. Changes in an engine idle load may come from a sudden shift into gear, operation of an HVAC system, power steering systems, power brake systems, and electrical charging and supply systems, for example. Engine temperature and transmission status, as well as lift and duration of the camshaft, can also change the engine load thereby changing the suitable engine idle load. Accordingly, it has been unexpectedly discovered that using signals from the engine, the environment and other factors to anticipate forthcoming engine loads can help ensure that the engine is operating at an efficient and effective engine idle speed while achieving a fuel economy and emissions reduction.

### SUMMARY

One or more aspects of the present technology relate to methods of operating an engine, for example, an engine in a motor vehicle. In one embodiment of the present technology, the method includes the step of determining the existence of an engine idle condition. The method may also include the step of determining whether an operator is in the motor vehicle. Based upon the determined engine idle condition and/or the presence of an operator, the method may further include operating the engine at a predetermined engine idle speed. For example, in certain embodiments, the method involves operating the engine at a performance idle speed when an idle condition exists and an operator is present in the motor vehicle to improve engine idle performance capabilities, such as the ability to bring a vehicle into gear without stalling. In other embodiments, the method can also include the step of operating the engine at a fuel economy idle speed when an idle condition exists and the operator is not present in the vehicle, to achieve high engine idle efficiency. In still further embodiments, the fuel economy idle speed will be lower than the performance idle speed. This allows the engine to operate at a level more suitable for performance when an operator is detected to be present, versus operating the engine at a level that is more fuel efficient when no operator presence is detected.

In another aspect, the present technology provides a further method of operating an engine in a motor vehicle. The method may include the step of determining the existence of a vehicle engine idle condition. In certain embodiments of this aspect of the present technology, when an engine idle condition is first determined, the engine is operated at a performance idle speed to improve engine idle performance capabilities. The method may also include the step of determining whether the vehicle is not in motion, or has not been in motion for a predetermined period of time. In other embodiments, when an engine idle condition exists and it is determined that the vehicle is not in motion, or has not been in motion for a predetermined period of time, the method can include the additional step of operating the engine at a fuel economy idle speed, which may be lower than the performance idle speed. This allows the engine to operate at a level more suitable for performance (e.g., gear change, vehicle take-off and the like) when it is anticipated that the vehicle will soon be in motion, versus operating the engine at a level that is more fuel efficient when it is anticipated that the vehicle will not soon be in motion.

### BRIEF DESCRIPTION OF THE DRAWINGS

FIG. 1 depicts a flow diagram for a method of controlling engine idle speed based on the presence of an operator in accordance with at least one embodiment of the present technology.

FIG. 2 depicts a flow diagram for a method of controlling engine idle speed based on the motion of a vehicle in accordance with at least one embodiment of the present technology.

FIG. 3 is a graph depicting the engine idle speed over time when an operator's presence is detected in accordance with at least one embodiment of the present technology.

FIG. 4 is a graph depicting the engine idle speed over time when an operator's presence has not been detected for a predetermined period of time in accordance with at least one embodiment of the present technology.

FIG. 5 is a graph depicting the engine idle speed over time as an operator's presence is detected, and later not detected, in accordance with at least one embodiment of the present technology.

FIG. 6 is a graph depicting the engine speed over time based on the measured engine coolant temperature (“ECT”) in accordance with at least one embodiment of the present technology.

FIG. 7 is a graph depicting the engine speed over time based upon the ECT and the presence of an operator in accordance with at least one embodiment of the present technology.

FIG. 8 is another graph depicting the engine speed over time based upon the ECT and the presence of an operator in accordance with at least one embodiment of the present technology.

### DETAILED DESCRIPTION

The present technology presents one or more methods and systems for controlling the idling speed of an engine. In particular, the present technology provides one or more methods and systems for controlling the engine idle speed based on the detected presence (or lack thereof) of a vehicle operator/occupant, and adjusting the engine idle speed based on the detected presence (or lack thereof) of that vehicle operator/occupant. For example, the presence of an operator in a vehicle may be detected by different signals, such as a brake pedal, an accelerator pedal, a clutch, or a parking brake. When one of these signals is detected, idle speed can be increased to a performance idle speed. In doing so, the present technology allows an engine to idle at a speed that is more suitable for performance when an operator is detected to be present, and alternatively or conversely at a level that is more fuel efficient when no operator is detected to be present. Certain aspects and respective embodiments of the present technology provide methods and systems for controlling engine idle speed based on the detected motion, movement, or momentum (or lack thereof) of a vehicle. This outcome allows the engine to operate at a level more suitable for performance when the vehicle is anticipated to be in motion, and at a level that is more fuel efficient when it is anticipated that the vehicle will not be in motion. Other aspects and embodiments of the present technology provide methods and systems for adjusting the engine idle speed based on the measured temperature of the engine, and the engine coolant, for example.

Engines can operate at various engine idle speeds to effectively balance the fuel efficiency and performance requirements of the engine. For example, an engine that is idling at a relatively low engine idle speed will use less fuel, produce lower levels of emissions and help keep the engine temperature at a cooler temperature than an engine operating at a relatively higher engine idle speed. However, an engine idling at such a low engine idle speed may, for example, stall if sudden loads are placed on the engine, such as if the engine is shifted into gear, or if the HVAC system is activated, etc. An engine operating at too low of an engine idle speed may also not be able to effectively perform certain functions, such as operating an HVAC system, power take off (“PTO”), bringing the engine into driving gear, sudden movement in a vehicle, or a vehicle starting on an uphill incline, for example, without creating problems such as stalling or engine knocking. Accordingly, it can be effective and efficient for an engine to shift between one or more lower, more economical engine idle speeds, and higher, more performance-ready speeds depending on the state of the engine, utilizing one or more methods of the present technology.

Anticipating future loads on an engine can surprisingly help make more efficient and more effective use of the engine idle speed. For example, if the workload of an idling engine is likely to increase, it may be useful to increase the engine idle speed to improve engine performance prior to the load being applied. However, if the workload of an idling engine is not anticipated to increase in a given time frame (e.g., within the next two minutes, or within the next five minutes, etc.), it may be more economical and more efficient, for example, to reduce that engine idle speed to conserve fuel and reduce emissions. The present technology provides unpredicted methods and systems for operating an engine that anticipate the forthcoming workload on an idling engine, and contemporaneously (or simultaneously, or sequentially, etc.) modify the engine idle speed accordingly.

At least one aspect of the present technology provides a method for operating an engine of a motor vehicle (e.g., a truck) that involves anticipating future engine workloads based on the presence, or lack thereof, of an operator in the vehicle. As described herein, an “operator” can include, but is not limited to an engine (or vehicle) operator (or driver), or to a vehicle passenger or occupant, for example. The method may also involve the steps of monitoring the engine condition, monitoring the presence of an operator in the vehicle, and then operating the engine at one or more of a pre-selected number of engine idle speeds based on the monitored engine condition and/or the presence of the operator.

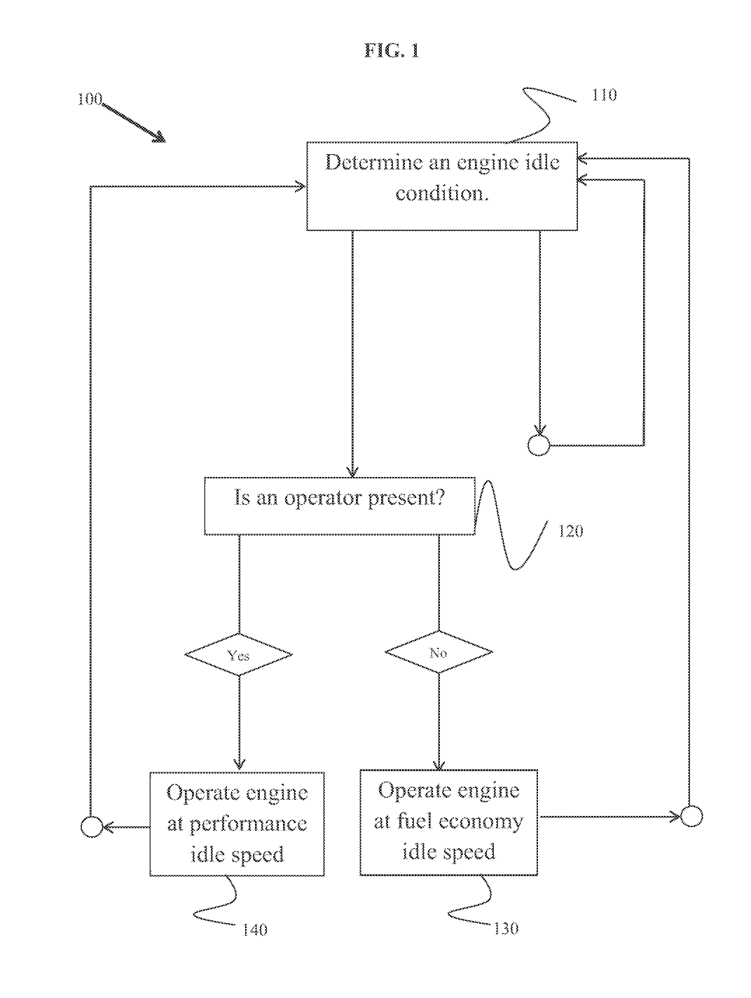

FIG. 1 depicts a flow diagram 100 for a method of controlling engine idle speed in an engine, (e.g., an engine for a motor vehicle) based on the presence of an operator, in accordance with at least one embodiment of the present technology. As depicted in FIG. 1, the method 100 determines whether an engine idle condition exists at step 110. For example, step 110 determines whether the engine is in an idling state or another state, such as an acceleration state or a performance state (e.g., an HVAC system has been activated). The engine idle condition can be determined, for example, when accelerator pedal has not been depressed and the engine speed is above a stalling speed. Other engine idle states can include, for example, a cold ambient protection (“CAP”) state, which is a state that can elevate the engine speed in colder temperatures when no operator present. Step 110 may be performed, for example, using a sensor or system of sensors and/or a computer or processor operating a software application. In some embodiments, an engine control module (“ECM”), comprising an engine speed control algorithm for detecting the engine idle state, can be used to perform step 110 of method 100. In certain embodiments, if the engine is not idling, then method 100 will operate in a positive or negative feedback loop manner, and cycle back to step 100 and continue to monitor for an idling condition of the engine. If the engine is idling, however, the method 100 proceeds to step 120 to determine whether an operator is present in conjunction with the information of the engine idle condition.

At step 120, the method 100 of the present technology monitors criteria corresponding to the presence of an engine operator. For example, where the idling engine is an engine in a motor vehicle, step 120 may monitor whether a vehicle operator is in the vehicle. Alternatively, at step 120, the method 100 may detect the presence or absence of an operator based on the position of an accelerator pedal or clutch pedal. That is, when a pedal is detected as being depressed, for example, the method 100 may determine that an operator is present. In other embodiments, the method may further determine whether a person is in a location capable of operating the vehicle, or in another location, such as a passenger's seat. For example, method step 120 may distinguish between a person sitting in the passenger seat of a vehicle from a person sitting in the driver's seat by using activation of a control that is operable from the driver's seat, but not another location of the vehicle, such as a clutch pedal, an accelerator pedal or a brake pedal. In such embodiments, where a person is detected to be present only in a passenger seat but not a driver's seat, the method step 120 may determine that no operator is present, for example. However in further embodiments, the presence of a passenger in only a passenger seat may result in a determination that an operator is present.

Thus, it should be appreciated that, in certain embodiments, step 120 may determine whether an operator is present using a pressure sensor, such as a pressure sensor in the seat of the vehicle. Where the pressure sensor indicates that a person is sitting in the driver's seat of the vehicle, step 120 may determine that an operator is indeed present, for example, and accordingly adjust the engine idle speed to anticipate a gear change or acceleration. In other embodiments, step 120 may also determine that an operator is present when, for example, a brake pedal, a clutch pedal, or an accelerator pedal is depressed via one or more sensors or systems associated with the motor vehicle.

In still further embodiments, step 120 can involve monitoring a vehicle condition that is capable of operating in multiple states. For example, step 120 may involve monitoring a vehicle condition that has a first and second state. Step 120 may also involve monitoring various engine or vehicle controls. For example, step 120 may include monitoring at least one of a clutch pedal, a brake pedal, an accelerator pedal, a pressure sensor, a voltage meter, a switch (such as an ignition switch or a signal switch), a parking brake, an air brake release, an HVAC control, a radio control, or combinations thereof to determine whether the engine is in the first or second state. In certain of such embodiments of the present technology, the method may determine that an operator is present when the vehicle condition is in the first state, and that an operator is not present when the vehicle condition is in its second state.

Moreover, the method step 120 may further include the step of monitoring both the internal and external areas of a vehicle. For example, method step 120 may include monitoring a passenger compartment and/or seating compartment of a vehicle using at least one of a motion sensor, a pressure sensor, a seat an actuator, a temperature sensor, an acoustic sensor, or a touch sensor to determine the presence of at least one operator in the vehicle. Step 120 may also determine the presence of at least one operator using an operator actuated controller. In certain embodiments, the operator actuated controller can detect the presence of an operator based on the activation or use of equipment or instruments associated with the engine. For example, the operator actuated controller may include one or more of a clutch pedal, a brake pedal, an accelerator pedal, a switch such as an engine ignition switch and a signal switch, a parking brake, an air brake release, and/or combinations or derivatives thereof. Moreover, the operator actuated controller may also include an HVAC control, PTO, a radio control of a vehicle, a seat adjustment control, a mirror adjustment control, an electronic dashboard control, or any other controls that an operator may be able to activate.

In additional embodiments, method step 120 may determine that an operator is present if an operator actuated controller has (or has not) been activated within a predetermined time period. Conversely, step 120 may also conclude that no operator is present if there has not been an activation of an operator actuated controller for a predetermined time period. In certain embodiments, the predetermined time period will be sufficient to distinguish between situations where a user is truly not present from situations where a user may be present, but not operating any controls of the motor vehicle. In at least one embodiment, the predetermined time period can vary depending upon the engine and its intended operated use. For example, in an embodiment where an operator activates an operator actuated controller relatively frequently (e.g., every 5 seconds on average), the method may implement a relatively shorter predetermined time period (e.g., 30 seconds). Conversely, in another embodiment, where an operator only activates a control relatively infrequently (e.g., every minute on average), it may be useful to implement a longer predetermined time period (e.g., five minutes). Such an embodiment reflects that a passenger, for example, may go a longer period of time without activating an operator actuated control or sensor, but still be present in the vehicle.

In certain embodiments involving a heavy duty application, the time to wait before dropping to fuel economy mode can be, for example, about five minutes. However, the time to bring the engine idle speed up to a performance idle speed when an operator's presence is detected can be shorter, and in certain embodiments can be immediate. For example, where an operator's presence is not detected for approximately five minutes, the engine idle speed may be reduced to a fuel economy idle speed. But when an operator's presence is once again detected, the engine idle speed can be immediately (or within a relatively short time frame, e.g., approximately about two seconds or less) brought up to a performance idle speed. In certain embodiments, the method 100 may reduce an engine idle speed to a fuel economy idle speed when an operator or driver is determined to be resting in the vehicle, or an operator or driver is determined to have stepped out of the vehicle (e.g., for a break). These events can be determined, for example, when the method has not detected the activation of an operator actuated controller for a predetermined time period. In certain embodiments, the predetermined time period can be determined, for example, by calibrating the engine and calculating a predetermined time period based on the engine's emissions, fuel economy, performance and customer requirements. In further embodiments of this aspect of the present technology, the predetermined period of time may range from about 15 seconds to about 10 minutes. In other embodiments, the predetermined period of time may range from about 1 minute to about five minutes. And in certain embodiments, the predetermined time period may be about 5 minutes.

If and when the presence of an operator is detected, method 100 of the present technology may then proceed to operate the engine at a predetermined engine idle speed. For example, if it is determined that there is no operator present in step 120, then the method may proceed to step 130 and operate the engine at a lower engine idle speed (e.g., about 600 rpm). The lower idling speed may be a fuel economy speed, for example, to increase fuel economy while in an idling state. In this embodiment, because the operator is not detected to be present, it can be anticipated that there is not an immediate demand for high system performance and/or functions (e.g., pressing the accelerator, or shifting the engine into gear). Accordingly, the overall engine system can operate at a lower, more fuel efficient engine idle speed, i.e., a fuel economy idling speed which in turn also lowers and/or controls emissions.

In some embodiments of the present technology, the fuel economy idle speed is controlled in such a predictive manner sufficient to prevent stalling of the engine. Alternatively or additionally, the fuel economy idle speed may also be a speed that does not impart substantial engine knocking or excessive engine idle vibration. Thus, the fuel economy idle speed can vary depending on the type of engine, the vehicle or other devices that the engine operates, and other functions of the engine. For example, a fuel economy idle speed may be between about 500 and about 700 rpm. In certain embodiments, the fuel economy idle speed may be between about 600 and about 650 rpm. And in certain embodiments, the fuel economy idle speed may be about 600 rpm. For heavy duty vehicles, for example, a suitable fuel economy idle speed can be about 600 rpm

If it is determined that an operator is present, then the method may proceed to step 140 and operate the engine at a relatively higher engine idle speed. The higher engine idle speed may be a performance idle speed (e.g., about 700 to about 750 rpm), for example, to allow the engine to operate at a more effective rate of performance if and when the operator activates various controls (such as an HVAC switch, gearing, or a radio control) or performs or initiates various engine operations (such as pressing an accelerator pedal). In some embodiments of the present technology, the performance idle speed of step 140 can be higher than the fuel economy idle speed of step 130. It should be appreciated by those skilled in the art that the performance idle speed can vary depending upon the type of engine, the vehicle or other machine that the engine operates, and other functions of the engine. For example, the performance idle speed of a large truck may be higher than the performance speed of a small car. In some embodiments, a performance idle speed may be between about 600 and about 800 rpm, for example. In certain embodiments, the performance idle speed may be between about 700 and about 800 rpm. And in certain embodiments, the performance idle speed may be about 700 rpm. For heavy duty vehicles, for example, a suitable performance idle speed can be about 800 rpm. In certain embodiments, a vehicle, such as a heavy duty vehicle that operates at a performance idle speed of about 800 rpm, may operate at a fuel economy idle speed of about 600 rpm. In certain embodiments, the performance idle speed and the fuel economy idle speed may be further determined in a manner that is intended to improve, enhance, and/or optimize emissions, fuel economy, performance and/or customer requirements.

When the method 100 operates the engine at the appropriate engine idle speed, the method 100 cycles back to step 110, thereby creating a repeating positive or negative feedback loop such that the method is continually monitoring both the engine idle condition and the presence of an operator or other predictive condition that allows for anticipating outcomes based upon the present technology. For example, when the engine is no longer idling, one method embodiment of the present technology will cease to operate the engine at either the fuel economy idle speed (i.e., step 130) or the performance idle speed (i.e., step 140), but will continually monitor the engine idle condition of the engine (i.e., step 110). Moreover, where the engine is idling and method step 120 detects a change in the presence of the operator, for example, the method will adjust the engine idle speed in an anticipatory manner. In at least one embodiment of this aspect of the present technology, when an engine is operating at a fuel economy idle speed (step 130) and it is determined (at step 120) that an operator has become present, the method will cease operating at a fuel economy idle speed (step 130) and begin operating at a performance idle speed (step 140). And, when it is determined that a user is no longer present, for example, because there has been no activation of an operator actuated control for a predetermined period of time, the method may reduce the engine idle speed to a fuel economy idle speed (step 130).

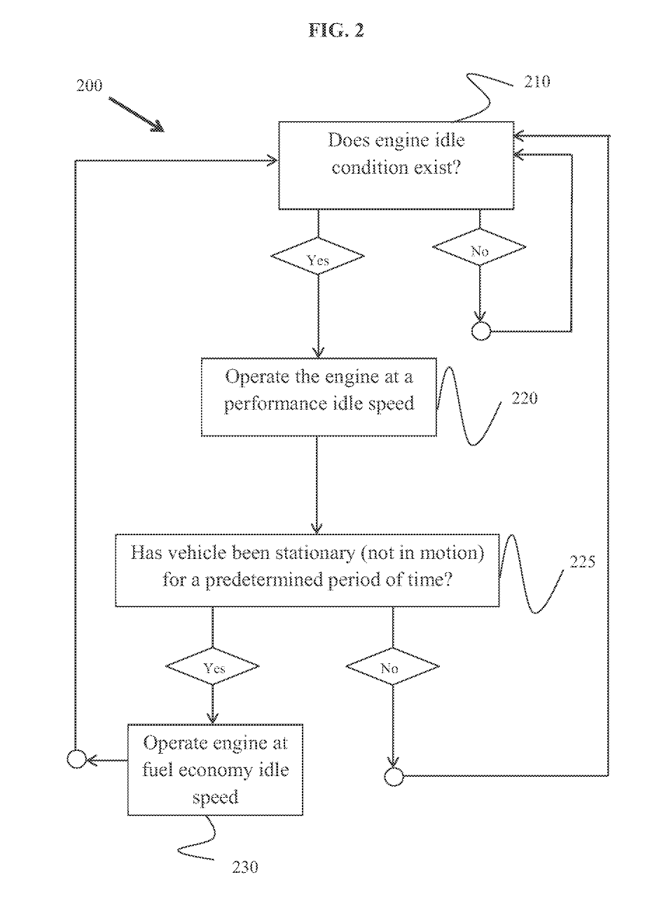

FIG. 2 depicts a flow diagram of a method 200 for controlling engine idle speed for an engine of a motor vehicle in accordance with another aspect of the present technology. As with method 100, the method 200 of FIG. 2 monitors the engine idle condition and operates the engine at one of a number of engine idle speeds based on the state of motion of a vehicle. The method 200 involves the step 210 of monitoring the engine idle condition of the engine. As depicted in FIG. 2, the method 200 determines whether an engine idle condition exists at step 210. At step 210, it is determined whether the system is in an idling state or another state, such as a fully operating state or a fully resting state. If the engine is not idling, then the method 200 cycles back and continues to monitor the idling condition of the engine.

If, for example, it is determined that the engine is idling, then the method 200 operates the engine at a performance idle speed (e.g., about 700 to about 800 rpm) at step 220. The performance idle speed can be, for example, the same performance idle speed used in step 140 of method 100. That is, the performance idle speed may be between about 600 and about 800 rpm, or more narrowly between about 700 and about 800 rpm or even more narrowly, about 700 rpm, for example. The performance idle speed should be higher than at least one predetermined fuel economy idle speed so that the engine is capable of efficiently performing various engine operations that may not necessarily be performable by an engine operating at a fuel economy engine idle speed. In other embodiments, the method may default to operating the engine at a lower engine idle speed at step 220, for example, a fuel economy idle speed (e.g., about 600 rpm).

While the method 200 continues to monitor the engine idle condition of the engine, the motion, or stationary status of the vehicle is also monitored in step 225. The stationary status of the vehicle may be monitored simultaneously, contemporaneously, sequentially or in parallel with the monitoring of the engine idle condition. At step 225, the method of the present technology may monitor, for example, whether the vehicle has been stationary or in motion for a predetermined period of time at step 225. The motion (or not) of the vehicle may be determined, for example, by monitoring the momentum, the acceleration or the velocity of the vehicle. In certain embodiments, the method will determine that the vehicle is not in motion if it is determined that the vehicle is coasting, operating at a low speed, operating at a low engine speed, operating at a rolling idle (or low idle) speed, for example. The step of determining whether the vehicle is stationary or not in motion for a predetermined period of time may comprise monitoring one or more of an accelerometer, a speedometer, a vehicle speed sensor, a global positioning system or another tracking device. In certain embodiments, when the method determines that an operator has returned to the vehicle, (e.g., when an operator actuated controller is activated), the engine idle speed will be raised to a performance idle speed. Accordingly, in certain embodiments, based on the anticipated movement of the vehicle based upon the detected returned presence of an operator, the engine idle speed will be operating at a performance idle speed at or before the time the vehicle begins moving.

If it is determined that the vehicle has been stationary for a predetermined period of time, then at step 230, the method operates the engine at a lower engine idle speed, for example, at a fuel economy idle speed. For example, if it is determined that the vehicle has been stationary for 60 seconds, then the method may operate the engine at a fuel economy idle speed of about 600 rpm. If the vehicle has not been stationary for a predetermined period of time, then the method will continue to operate the engine at a performance idle speed or another predetermined engine idle speed. The fuel economy idle speed can be, for example, the same fuel economy idle speed used in step 130 of method 100 (e.g., about 600 to about 800 rpm, about 700 to about 800 rpm, or about 700 rpm). In certain embodiments the fuel economy idle speed is lower than the performance idle speed making the engine more fuel efficient and resulting in the production of lower emissions (e.g., NOx and soot).

In further embodiments, the predetermined period of time for lowering the engine idle speed based on vehicle movement of method 200 can be longer than, shorter than, or the same as the predetermined time period for determining the presence of an operator of method 100. Moreover, the predetermined time period can vary depending on the type of vehicle (e.g., passenger, commercial, military, etc.) that the engine is installed in, and the particular task (passenger travel, commercial hauling, military uses, etc.) for which the vehicle is being used. For example, in certain embodiments, the predetermined period of time may range from about 15 seconds to about 10 minutes. In certain embodiments, the predetermined period of time may range from about 1 minute to about five minutes. And in certain embodiments, the predetermined time period may be about 5 minutes.

If and when the engine idle speed is reduced to a fuel economy idle speed at step 230, the method cycles back to step 210 so as to monitor the engine idle condition. In this manner, method 200 operates in a operating positive or negative feedback cycle. In operation, method 200 anticipates that a vehicle that has been at rest for a predetermined period of time will likely continue to remain at rest and, therefore, be able to conserve fuel and reduce emissions by lowering the engine idle speed while the vehicle is not in use and/or in motion. In certain embodiments of the present technology, method 200 may further comprise the additional step of monitoring for the presence of an operator. For example, method 200 may include step 120 of method 100. For example, when an engine is operating at a fuel economy idle speed, and the presence of an operator, passenger or actuator activation event is detected, method 200 will then operate the engine at a performance idle speed (i.e., a relatively higher engine idle speed). The detection of an operator can be monitored, for example, by monitoring an operator actuated controller. Additional examples of such operator, passenger, or actuator activation events are provided herein, supra. Additionally, the presence of an operator (or passenger or occupant) can be monitored by any of the methods described with respect to step 120 of method 100. In further embodiments, method 200 will return the engine to operation at a performance idle speed when an operator actuated controller has been actuated during a predetermined time period.

It should be appreciated by those skilled in the art that methods 100 and 200 or other methods of the present technology can be carried out by systems used relative to an engine, such as an engine control module for a motor vehicle. The systems may also comprise, for example, an engine, a system of sensors and/or operator actuated controllers, one or more timers and one or more processors and/or controllers operating an engine controlling software application. The engine controlling software application may be preprogrammed with the functions and commands suitable for operating the methods described by the present technology herein. For example, the engine controlling software may be preprogrammed with the predetermined time period for establishing the presence, or lack thereof, of an operator (or passenger or occupant). In certain embodiments, the engine controlling software may be preprogrammed with the various engine idle speeds. For example, the software application may be preprogrammed to operate the engine at a fuel economy idle speed of about 600 rpm (or more broadly at a range of about 600 to about 650 rpm, about 600 to about 700 rpm, or about 500 to about 700 rpm, for example) and a performance idle speed of about 700 rpm (or more broadly at a range of about 700 to about 750 rpm, about 700 to about 800 rpm, or about 600 to about 800 rpm, for example) in some embodiments. In certain embodiments, the systems may carry out methods, such as method 100 and 200 described above, automatically, without receiving direct input or feedback from a system operator.

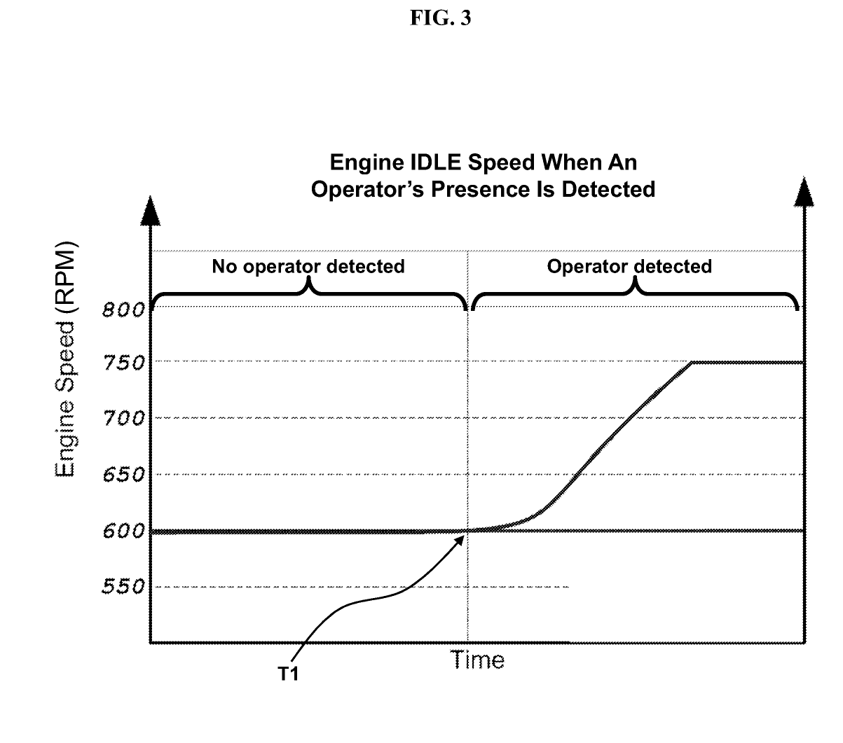

FIGS. 3, 4 and 5 are graphs depicting examples of an engine speed over time based on the performance of various methods of the present technology. FIG. 3 is a graph depicting the engine speed over time when a driver's presence is detected in accordance with method 100. In FIG. 3, the engine is initially operating at a fuel economy idle speed (e.g., about 600 rpm). At time T1, the presence of an operator is detected, and the engine idle speed of the engine is increased accordingly to a performance idle speed (e.g., about 750 rpm).

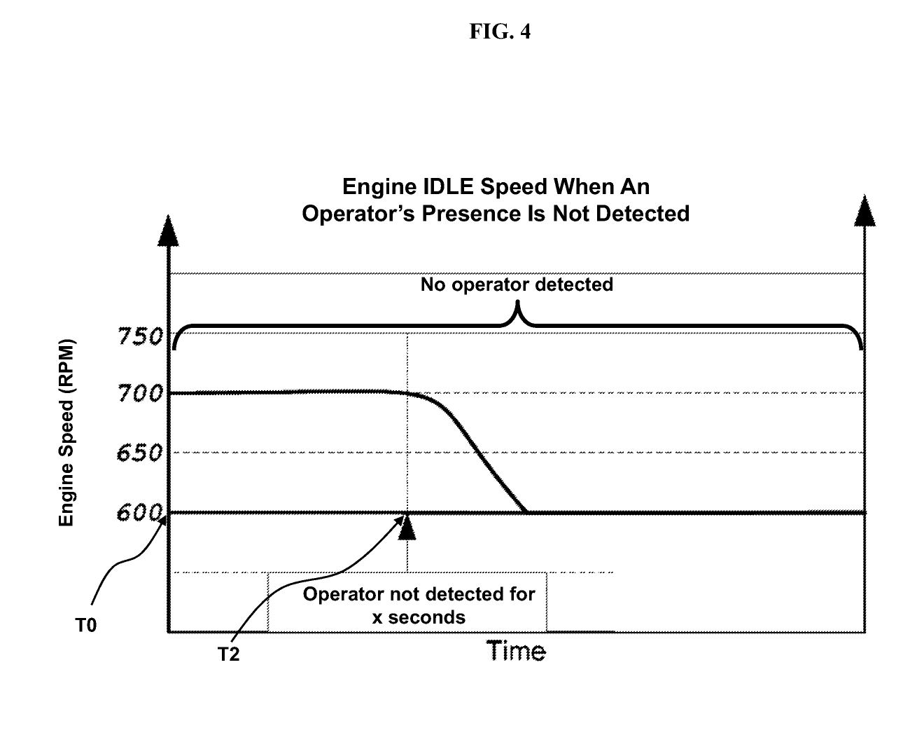

FIG. 4 is a graph depicting the engine speed over time when an operator's presence has not been detected for a predetermined period of time in accordance with method 100. In FIG. 4, the engine has been operating at a performance idle speed (e.g., about 700 rpm); however, there is no operator detected. Time T2 represents the moment where a predetermined time has transpired (“x” seconds, which can be 15 seconds, 60 seconds, 120 seconds or more, for example) since an operator was last detected. Accordingly, at time T2, the method 100 determines that an operator is not present and thus reduces the engine idle speed to a fuel economy idle speed (e.g., about 600 rpm). In certain embodiments, the decrease of the engine idle speed can act as an overdamped PI controller as the engine idle speed reduces.

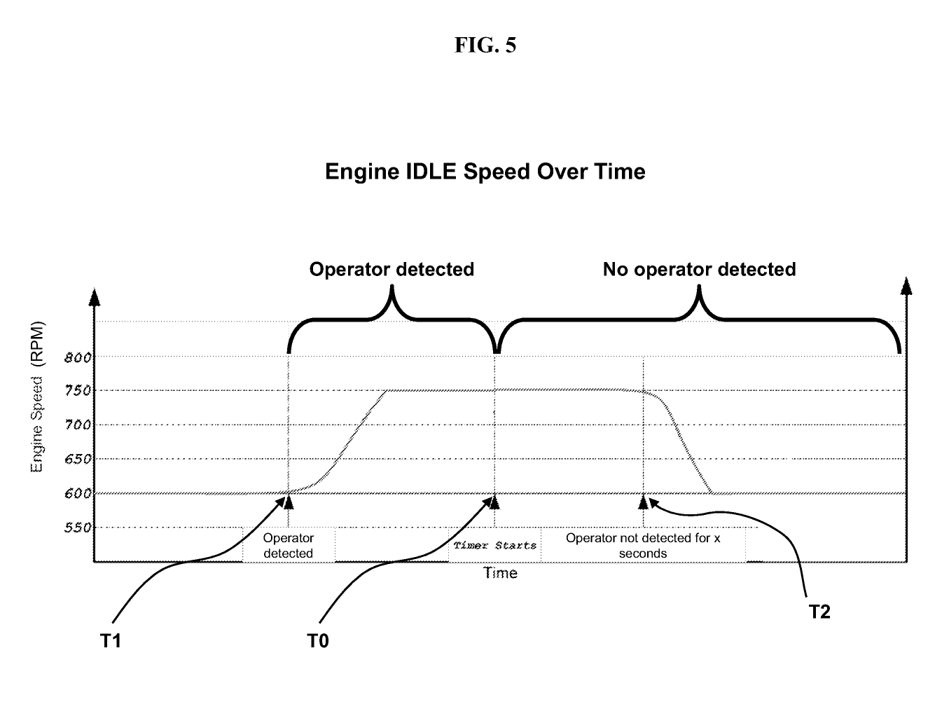

FIG. 5 is a graph depicting the engine idle speed over time as an operator's presence is detected, and then later not detected in accordance with at least one embodiment of the present technology. Initially, no operator is detected and thus the engine is idling at a fuel economy idle speed (e.g., about 600 rpm). At time T1, an operator's presence is detected, and the engine idle speed is increased to a performance idle speed (e.g., about 750 rpm). At time T0, the operator's presence is no longer detected, and a timer or timing event begins. After a predetermined time period (“x” seconds, which can be 15 seconds, 60 seconds, 120 seconds or more, for example) for which the operator's presence is still not detected, the engine idle speed reduces to the fuel economy idle speed (e.g., about 600 rpm).

As described above, certain methods and systems of the present technology anticipate future workloads on an engine and control engine idle speed accordingly. The methods may adjust the engine idle speed between a relatively higher performance idle speed and a relatively lower fuel economy idle speed based on anticipated future engine workloads (or lack thereof). These described systems and methods may control the engine idle speed based on detected conditions, such as, for example, the detection of a present operator (based upon the detected activation of one or more operator actuated controllers), and the recent motion, or lack thereof, of a vehicle. Alternative embodiments of the present technology may also provide methods and systems that implement more than two engine idle speeds. For example, in certain embodiments, methods and systems may apply a first performance idle speed and a second performance idle speed, such that the first performance idle speed is higher than the second performance idle speed. Moreover, certain embodiments may provide methods and systems that provide a first fuel economy idle speed and a second fuel economy idle speed such that the first fuel economy idle speed is higher than the second fuel economy idle speed. In certain embodiments, the first fuel economy idle speed may be close to, the same as, or even higher than a second (or third or fourth, etc.) performance idle speed. Additionally, certain embodiments may provide more than two different engine idle speeds and/or more than two different fuel economy idle speeds. For example, in certain embodiments, methods and systems may implement three, four, five or more different performance idle speeds and/or fuel economy idle speeds.

It should be appreciated by those skilled in the relevant art that one or more methods of the present technology can implement one or more of the engine idle speeds based on a variety of different measurable or detectable conditions or factors. For example, engine coolant temperature (“ECT”) may be a factor used to control one or more of the various engine idle speeds. Other conditions and factors that may be used to control engine idle speed can include, but are not limited to the amount of fuel in a vehicle's fuel tank, the operation of a vehicle's HVAC system, ambient temperature, engine oil pressure and/or combinations or derivations thereof.

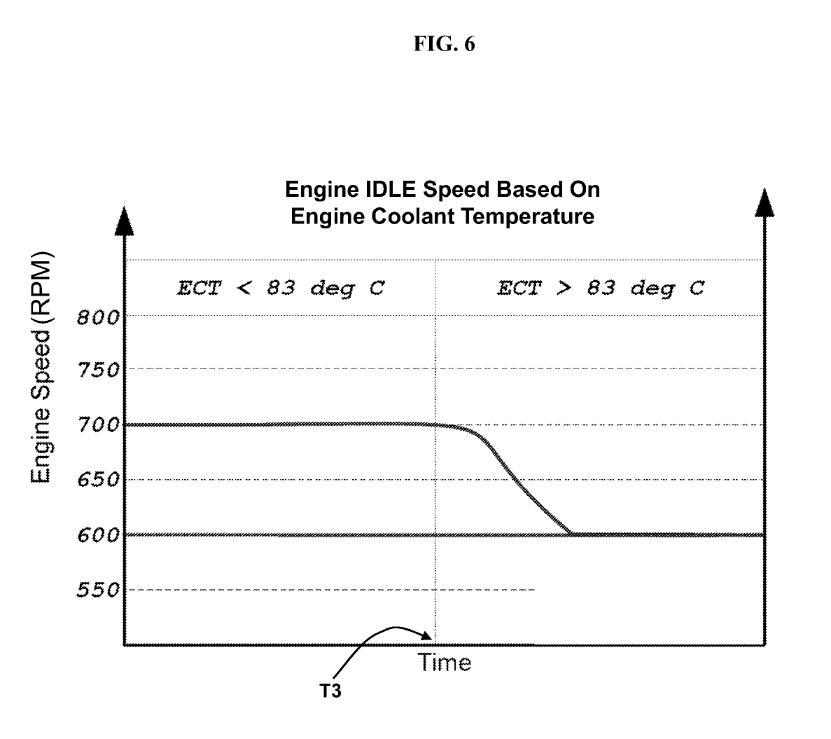

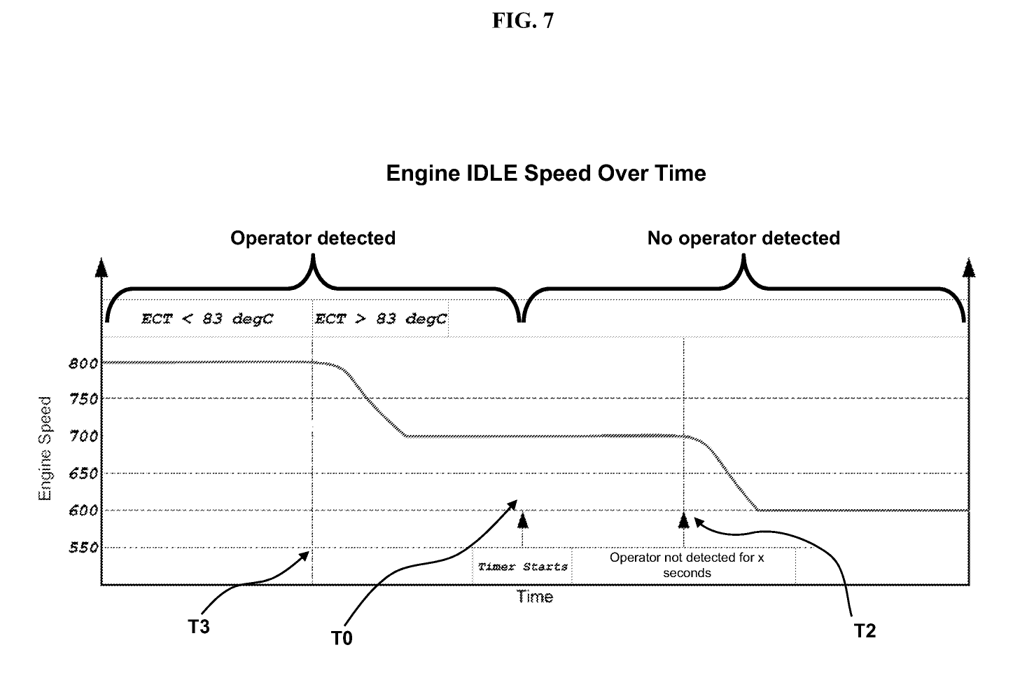

FIG. 6 is a graph depicting the engine speed over time based on the measured ECT in accordance with at least one embodiment of the present technology. In this embodiment, an engine may operate at a performance idle speed while the ECT is below a predetermined temperature, and then operate at a fuel economy idle speed once the ECT rises above a predetermined temperature. In FIG. 7, the predetermined temperature is about 83° C. On the left side of the graph, the ECT is measured to be below 83° C., thus the engine is idling at a higher engine idle speed (e.g., about 700 rpm). At time T3, however, the ECT rises to and/or above the predetermined value of 83° C., and the engine idle speed is then reduced to a lower idle speed (e.g., about 600 rpm).

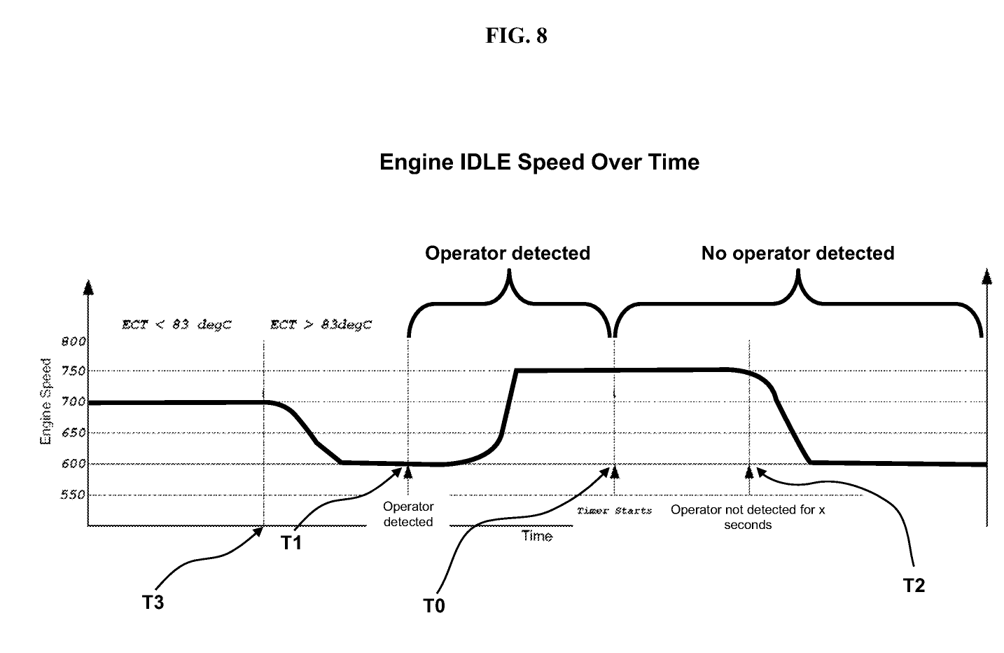

FIGS. 7 and 8 are graphs depicting the engine speed over time based upon the engine coolant temperature and the presence of an operator in accordance with an embodiment of the present technology. In FIG. 7, an operator is initially detected (left side of the graph) and the ECT is less than a predetermined threshold (e.g., about 83° C.); therefore, the engine is operating at a first performance idle speed (e.g., about 800 rpm). At time T3, the ECT rises above the predetermined threshold, and the engine idle speed is reduced to a second performance idle speed (e.g., about e 700 rpm) while the presence of the operator is still detected. At time T0, the presence of the operator is no longer detected, and a timer begins running. At time T2, a predetermined time period (“x” seconds, which can be 15 seconds, 60 seconds, 120 seconds or more, for example) has transpired with no operator being detected, and the engine idle speed is thus reduced to a fuel economy idle speed (e.g., about 600 rpm).

FIG. 8 is another graph depicting the engine speed over time. In FIG. 10, an operator is initially not present and the ECT is below the predetermined threshold (e.g., 83° C.); therefore, the engine is operating at a first fuel economy idle speed (e.g., about 700 rpm). At time T3, the ECT reaches the predetermined threshold (i.e., 83° C. or above), and the engine idle speed is reduced to a second fuel economy idle speed (e.g., about 600 rpm). At time T1, the presence of an operator is then detected, and the engine idle speed is then increased to a performance idle speed (e.g., about 750 rpm). At time T0, the presence of the operator is no longer detected, and a timer begins running. At time T2, a predetermined time period (“x” seconds, which can be 15 seconds, 60 seconds, 120 seconds or more, for example) has transpired with no operator being detected, and the engine idle speed is thus reduced to a fuel economy idle speed (e.g., about 600 rpm).

FIGS. 3 through 8 are graphs charting exemplary and unexpected results of engine control methods in accordance with various embodiments of the present technology. These graphs, however, are merely exemplary models based on hypothetical conditions and potential features of the present technology. The present technology is in no way limited the embodiments depicted therein.

The present technology provides unexpected and surprising results that allow an engine idle speed to be anticipatorily controlled so that sudden work loads do not cause the engine to stall, while also allowing the engine to reduce emissions and pollutants and increase fuel economy. The present technology anticipates engine workloads based on various indicators, such as the presence of an operator in a vehicle, the recent motion (or lack thereof) of a vehicle and the engine temperature, for example. By anticipating and/or predicting future engine loads, the present technology allows an engine to operate at an engine idle speed that is suitable for performance when engine workloads are likely, and at an engine idle speed that is more economical and efficient when engine workloads are less likely.

What is claimed is:

1. A method of operating an engine in a motor vehicle comprising:
determining the existence of an engine idle condition;
determining whether an operator is in the motor vehicle;
operating the engine at a performance idle speed when an idle condition exists and the operator is in the motor vehicle; and
operating the engine at a fuel economy idle speed, which is lower than the performance idle speed, when an idle condition exists and the operator is not present in the motor vehicle.

2. The method of claim 1, wherein the step of determining whether an operator is in the motor vehicle comprises monitoring an operator actuated controller to determine whether the operator actuated controller has not been activated during a predetermined time period.

3. The method of claim 1, wherein the operator actuated controller comprises at least one of a clutch pedal, a brake pedal, an accelerator pedal, an ignition switch, a pressure sensor, an ignition switch, a signal switch, a parking brake, an air brake release, and a radio control.

4. The method of claim 1, wherein the step of determining whether an operator is present in the motor vehicle comprises:
monitoring a vehicle condition that has a first state and a second state;
determining that an operator is present when the vehicle condition is in its first state, and determining that an operator is not present when the vehicle condition is in its second state.

5. The method of claim 1, wherein the step of monitoring a vehicle condition comprises monitoring at least one of a clutch pedal, a brake pedal, an accelerator pedal, a pressure sensor, an ignition switch, a signal switch, a parking brake, an air brake release, and a radio control.

6. The method of claim 1, wherein the step of determining whether an operator is present in the motor vehicle comprises monitoring a passenger compartment of the vehicle with at least one of a motion sensor, a pressure sensor, an actuator, temperature sensor, acoustic sensor.

7. A method of operating an engine in a motor vehicle comprising:
determining the existence of a vehicle engine idle condition;
operating the engine at a performance idle speed when the existence of a vehicle idle condition is first determined;
determining whether the vehicle is not in motion for a predetermined period of time; and
operating the engine at a fuel economy idle speed, which is lower than the performance idle speed, when an idle condition exists and the vehicle is not in motion for the predetermined period of time.

8. The method of claim 7, wherein the step of determining whether the vehicle is not in motion for a predetermined period of time comprises determining whether the vehicle has a lack of a momentum for the predetermined time period.

9. The method of claim 7, wherein the step of determining whether the vehicle is not in motion for a predetermined period of time further comprises monitoring at least one of an accelerometer, a speedometer, a vehicle speed sensor, and a global position system.

10. The method of claim 7, further comprising in addition the step of monitoring an operator actuated controller and returning to operation of the engine at a performance idle speed when the controller has been actuated during a second predetermined time period.
